(19) United States
(12) Patent Application Publication
(10) Pub. No.: US 2010/0235365 A1
(43) Pub. Date: Sep. 16, 2010

(54) PS9110 Linear time sorting and constant time searching algorithms

(76) Inventor: Marvon M. Newby, JR., Crestview, FL (US)

Correspondence Address: Marvon M. Newby, Jr., 4119 Lakeview Drive, Crestview, FL, 32539-8026, US

(21) Appl. No.: 12/381,427

(22) Filed: Mar. 13, 2009

(51) Int. Cl. G06F 17/30; G06F 12/00

(52) U.S. Cl. 707/752; 711/216; 711/E12.001; 707/E17.014; 707/E17.058

(57) ABSTRACT

System and methods are described for sorting information in order O(n) time using O(n) space and searching for information in that sorted list in order O(1) time by using one single dimensioned array, without the use of other data structures and techniques, parallel processing, recursion, or other-sorting algorithm.

### CROSS-REFERENCE TO RELATED APPLICATIONS

Not Applicable

### STATEMENT REGARDING FEDERALLY SPONSORED RESEARCH AND DEVELOPMENT

Not Applicable

### FIELD OF THE INVENTION

This invention relates to SORTING and SEARCHING apparatuses and methods for use with sorting data into a sorted list and searching data in said sorted list. In particular, in accordance with one embodiment, the invention relates to sorting data into a sorted list in linear time and searching said sorted list in constant time. This invention relates to data structures and sorting searching algorithms that are used by computer programs such as databases, electronic spreadsheets, and any other devise that employs sorting information or searching for information in a sorted list.

### BACKGROUND OF THE INVENTION

Sorting data is used from the kernel of an Operating System (OS) to very large databases. Although the amount of computer time used in sorting data varies from application to application, it is estimated that one fourth to one half of all Central Processing Unit (CPU) time is spent on sorting data. Because such a large percentage of time is spent sorting data, the efficiency of the sorting algorithm that is used is very important to computer and other applications.

Sorting algorithms can be classified into three basic groups based on their sorting efficiencies. These groups and some representative algorithms are:
O(n²) sorts include Bubble, Cocktail, Exchange, Gnome, Selection, Insertion, . . .
O(n log n) sorts include Binary, Heapsort, Library, Merge sort, Smoothsort, . . .
O(n) sorts include Bucket, Counting, Comb, Flashsort, and Radix sorts (LSD/MSD) . . .

Each of these sorts can be broken down by the technique that they used. Comparison sorts are represented by exchange (Bubble sort), selection and insertion techniques. Second, they can be broken down by the data structure that they use. Arrays, linked lists, trees etc. Third, they can be broken down into two groups based on when sorting takes place. In the Bubble and Selection sorts, the sorting takes place after the data has been placed into the sort array. In the Insertion sort, the sorting takes place as each data point is placed into the array. Fourth, they can be identified by the “helpers” that they use. Examples of such helpers are pointers, links, and tables. Many of the techniques used to reduce the order of complexity, also causes increase work for the computer's CPU.

The efficiency of each sort is limited by three main technology problems. First, there is the problem of moving the data or pointers. There is nothing we can do about moving the data to the sort array (or any other data structure) and then moving it from that structure to the output. The cost is 2*n. One n to move the data to the structure used to sort the data, and one n to move the sorted data from the structure to the output. (One less n if the data structure that the data points are initially stored is used for the sorting.) In all data structures, swapping data is very expensive. It takes three moves in an array and move of six pointers in a doubly linked list. Second, there is the problem of linear searches. Although less expensive than moves or swaps, there are many of them. Third, recursion is sometimes necessary because the list is not sorted in one pass. The divide and conquer algorithms like the binary sorts limit this, but it is still an order O(n log n) process.

Applicant's Sorting and Searching system and methods minimize the recursions, searches, moves, and swaps used to both sort and search the data.

### BRIEF SUMMARY OF THE INVENTION

First, Applicant's Sorting and Searching system and method minimizes recursion by sorting the data when the data is moved into the sort array. There are only three loops used to move the data into the sort array, sort the data, and then move the data out of the sort array. The first and last loops are of order O(n) since each one moves n data points into and out of the sort array. The second loop is of order O(1). Even though it is inside the first loop, it is rarely used and when used has few iterations. The total usage of this loop adds approximately ⅓ n to the total processing time when the memory multiplication factor (f) is set to 2.00. Therefore the total efficiency of the algorithm is of order O(n), or around 3.3n as compared to 2n+n log₂n or n*(2+log₂n) for binary sorts.

Second, data searching has been minimized by using a hashing function for the initial location of each data point. The same hashing function must be used for both the sorting and searching algorithms. This enables the algorithm to search a sorted list in constant time.

Third, the use of “data holes” created by the “memory multiplication factor” minimizes the movement of data. When a collision occurs, the largest data point value is moved to the next position in the array. Because the data structure uses data holes, the next position is likely to be a hole and thus limit the insertion loop to a few iterations, if used at all.

### BRIEF DESCRIPTION OF THE SEVERAL VIEWS OF THE DRAWING

Hashing function for and array A:

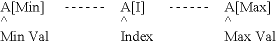

First, let C=(n*f)/(Max Val−Min Val) where n is the number of data points and f is the memory multiplication factor. In these examples f=2.00 is used for convenience.
Min=(Min Val−Min Val)*C=0*C=0 or the first element of the array.
Index=(Data Val−Min Val)*C=d*C which positions the data initially.
Max=(Max Val−Min Val)*C=n*f which is the top value for array.

Worst case scenario requires that the sort array be of size (f+1)*n although very seldom are more than 1.05*f*n positions required. Also assumes that the first element of the array starts at position zero (0). If your data structure starts arrays with position one (1) then add one to all values.

The purpose of the hashing function is to skip over all the array positions between A[I] and A[Min] thereby reducing search efficiency from O(n) to O(1). The Purpose of the holes is to limit iterations of the inner loop.

Insertion of data into sorted array (Inner Loop):

Assumes that the value zero is not in the range of values to be sorted, else you must initialize array to (Min Val−1) or some other constant that is not in the range of the array.

While not sorted Do

| | | |
|---|---|---|
| 1 | If A[I] is zero Then | Move Data Value to |
| | | A[I] and exit while loop |
| | A[I] = Data Value; | |
| | Exit Loop; | |
| 2 | Else If A[I] < Data Val Then I = I+1; | Look at next position |
| 3 | Else | Swap values and look at |
| | | next position |
| | Temp = A[I]; | |
| | A[I] = Data Value; | |
| | Data Value = Temp; | |
| | I = I + 1; | |
| | End If | |

Loop

Although this is a loop, it is rarely performed. When it is performed, it is rarely executed more than a few times for values of f>1.50. A sequence for inserting “B” into and array:

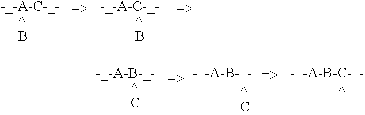

A[Data Val]=A is not zero, “If A[I] is zero” is skipped.
A[Data Val]=A is less than Data Val=3, so array is incremented to A[ Data Val+1].
Loop back to beginning.
A[Data Val+1]=C is not zero, so “If A[I] is zero” is skipped again.
A[Data Val+1]=C is NOT less than Data Val=B, so Else if section is also skipped.
Else causes the data to be swapped and the array index pointer to be incremented.
Loop back to beginning.
A[Data Val+2]=0, so C is moved to that position and the loop is exited.

At this point the array is sorted may look something like this with data holes in the array.

-_-A-B-C-_-E- -_-F-G-_. . . -X where “_” represents the data holes.

### DETAILED DESCRIPTION OF THE INVENTION

The following algorithms (written in pseudo code), in accordance with Applicant's invention, require one pass of the data or prior knowledge to know what the highest value (Hval), the lowest value (Lval), the number of data elements (n), and the memory expansion factor (f) to be used (input by the programmer or defaulted) and that the sort array size is (f+1)*n. {In this example assume that f=2.} Also required is that the sort array is initialized to some value outside the Hval to Lval range.

```
    PS9110SORTLIST(Hval, Lval, n, f, INarray[n], OUTarray[n])
  Dim SORTarray[(f+1)*n)] = 0
  Slot_size = (f * n) / (Hval − Lval)
```

| | |
|---|---|
| For I = 1 to n | ‘ This is outer loop 1 |

```
    Index = Int(INarray[I] − Lval) * Slot_size
    More = True
```

| | |
|---|---|
| While (More) Do | ‘ This is minimally used inner loop 2 |

```
      If (SORTarray [Index] == zero) then
        SORTarray [Index] = INarray[I]
        More = False
      Else
        If ( INarray[I]< SORTarray [Index]) then
          Switch = SORTarray [Index]
          SORTarray [Index] = INarray[I]
          INarray[I]= Switch
        End If
        Index = Index + 1
      End If
    End Do While
  End For Loop
  I = 0, j = 0
```

| | |
|---|---|
| While I < n Do | ‘ This is loop 3 |

```
    If SORTarray [I] NOT Zero Then
      OUTarray [J] = SORTarray [I]
      J = J + 1
    End If
    I = I + 1
  End Do While
  Return OUTarray[n]
End PS9110SORTLIST
    PS9110SEARCHLIST(Hval, Lval, n, f, INarray[n], SORTarray
    [(f+1)*n])
```

| | |
|---|---|
| Dim SORTarray[(f+1)*n)] = 0 | If the data is to be used for searching. |

Slot_size = (f * n) / (Hval − Lval)

| | |
|---|---|
| For I = 1 to n | ‘ This is outer loop 1 |

```
    Index = Int(INarray[I] − Lval) * Slot_size
    More = True
```

| | |
|---|---|
| While (More) Do | ‘ This is minimally used inner loop 2 |

```
      If (SORTarray [Index] == zero) then
        SORTarray [Index] = INarray[I]
        More = False
      Else
        If ( INarray[I]< SORTarray [Index]) then
          Switch = SORTarray [Index]
          SORTarray [Index] = INarray[I]
          INarray[I]= Switch
        End If
        Index = Index + 1
      End If
    End Do While
  End For Loop
  I = 0, j = 0
  Return SORTarray [(f+1)*n]
End PS9110SEARCHLIST
    PS9110SEARCH(SearchVal, Hval, Lval, n, m, SORTarray
    [(f+1)*n])
  Index = (SearchVal − Lval) * (f * n) / (Hval − Lval)
  More = True
  Found = False
  While (More)
    If (SORTarray [Index] == zero) or
      (SORTarray [Index] > SearchVal) then
        More = False
    Else
        If (SORTarray [Index] = SearchVal) then
            Found = True
            More = False
        End If
        Index = Index + 1
    End If
  End While
  Return Found
End PS9110SEARCH
```

Various languages and logic constructs implement arrays and loops using different syntaxes and methods. Use of different methodologies or languages to construct the algorithms from this pseudo code does not invalidate the patent.

Before sorting the data the PS9110 Sorting algorithm requires information on the highest value, lowest value, and number of values to be sorted. These can either be given or obtained by one pass through the values to be sorted. The PS9110 Sorting and Search algorithm set is the only set of algorithms where the programmer determines how much memory is to be used by the computer.

The PS9110 Search algorithm must use the same values that the PS9110 Sorting algorithm used.

Unlike other algorithms, the amount of memory used by PS9110 determines the efficiency of sorting and searching data. This amount can be determined by the programmer, or a default value (usually around f=2.00) can be used. A memory multiplication factor (f) must be used in both the sort and search algorithms. The memory multiplication factor (f) is a coefficient greater than 1.00 and is used obtain how much memory is used to sort the information. The amount of computer memory (m) use is found by the formula m=(f+1)*n where n is the number of values to be sorted. When f is close to 1.00 the algorithm sorts in order O(n²) time. In most cases if f>1.50 then the PS9110 Sorting algorithm sorts most data sets in order O(n) time. Optimal values usually occur when the value of f is 2.00<f<4.00. Values greater than 4.00 usually do not produce significant gains.

The PS9110 Sorting algorithm accomplishes O(n) sorting efficiency by the employment of two principles. First, it employees a hashing function to initially place the sorted data very close to its final position. This hashing index is calculated using the highest value, the lowest value, the data to be sorted value, the number of values (n), and the memory multiplication factor (f). Since all values, except for the data to be sorted value, are constants, they can be computed and reduced to a single constant (c) before sorting begins. The sorted value is placed very close to its final position with the hashing index computed with the formula:

Index=(sort value−low value)/(high value−low value)*(f*n) or as stated earlier, where c=(f*n)/(high value−low value), Index=(sort value−low value)*c.

Second, the memory magnification factor (f) places holes to breakup data clusters. This increases the processing efficiency from O(n²) to O(n). With f=2.00 efficiencies around 4/3 n are achieved to sort the data. Likewise, searching for data in this sorted list results in 4/3 attempts per hit or confirmed miss. The PS9110 Sorting and Searching algorithms are O(log₂n) faster than binary sorting and searching algorithms. The PS9110 Sorting algorithm must remove the holes created by the memory multiplication factor (f) when creating a concatenated output list. When f=2.00, total cost is approximately 3.33n versus 2.00n+n log₂ n for a binary sort.

The invention is described in some detail with specific reference to a single preferred embodiment and certain alternatives. There is no intent to limit the invention to that particular embodiment or those specific alternatives. Thus, the true scope of the present invention is not limited to any one of the foregoing exemplary embodiments but is instead defined by the claims.

The present invention provides systems and methods for data sorting and search using a hashing function, insertion and loop limiting (data hole) techniques. The techniques described herein may be implemented in hardware or software, or a combination of both. Preferably, the techniques are implemented in computer programs executing on programmable computers. Each program is usually implemented in a high level procedural or object oriented programming language. However, the programs may be implemented in assembly or machine language.

Although exemplary embodiments of the invention has been described in detail above, those skilled in the art will readily appreciate that many additional modifications are possible in the exemplary embodiments without materially departing from the novel teachings and advantages of the invention. There is no intention to limit this invention to the specific constructions and claims described herein. Accordingly, these and all such modifications, alternative constructions, and equivalents are intended to be included within the breadth and scope of this invention construed in accordance with the spirit of the following claims.

What is claimed is:

1. A data sorting method comprising:
a. an array of consecutive memory locations wherein the array size is larger than the number of data points (n) to be sorted wherein the insertion of data points leave holes in the array that are not used.

2. The invention of claim 1, further includes a hashing function wherein the hashing function evenly distributes data in the array and wherein the hashing function determines the initial position of the data in the array.

3. The invention of claim 1 further including an insertion function wherein the insertion function determines the final position of the data in the array, wherein the insertion function may move data already placed into the array, and when the insertion function moves data the greater value is always moved to a higher array position.

4. The invention of claim 1 wherein the efficiency of the sort depends on the size of the array compared to n, wherein the of order O(n) for most array sizes greater than 1.5*n.

5. The invention of claim 4 further including a transfer function that transfers sorted data to an output array, wherein the transfer function concatenates the sorted data and removes data holes by a concatenation process, wherein the efficiency of the transfer is of order O(n) and is directly related to the size of the array, and wherein the efficiency of sorting and transferring is of order O(n) for array sizes greater than 1.5*n.

6. The invention of claim 2 further including a searching function, wherein the searching function uses the same hashing function as the sort method for initial position, wherein the searching function uses a linear search function for final position, and wherein the searching function is of order O(1).
